(19) United States
(12) Patent Application Publication
(10) Pub. No.: US 2025/0307714 A1
(43) Pub. Date: Oct. 2, 2025

(54) MACHINE LEARNING PROGRAM, METHOD, AND APPARATUS

(71) Applicant: Fujitsu Limited, Kawasaki-shi,Kanagawa (JP)

(72) Inventor: Ryosuke SONODA, Yokohama (JP)

(73) Assignee: Fujitsu Limited, Kawasaki-shi (JP)

(21) Appl. No.: 19/238,994

(22) Filed: Jun. 16, 2025

Related U.S. Application Data
(63) Continuation of application No. PCT/JP2023/004458, filed on Feb. 9, 2023.

(51) Int. Cl. G06N 20/00

(52) U.S. Cl. CPC G06N 20/00

(57) ABSTRACT

A machine learning apparatus a processor that executes a procedure. The procedure includes: calculating an independence between a prediction result in a case in which each of a plurality of items of unlabeled data is input to a machine learning model, and a value of a first attribute of each of the plurality of items of data; selecting first data from the plurality of items of data based on the independence; acquiring a label of the first data; and executing training of the machine learning model based on the first data and the label.

### CROSS-REFERENCE TO RELATED APPLICATION

This application is a continuation application of International Application No. PCT/JP2023/004458, filed Feb. 9, 2023, the disclosure of which is incorporated herein by reference in its entirely.

### FIELD

The disclosed technology relates to a machine learning program, a machine learning method, and a machine learning apparatus.

### BACKGROUND

Hitherto, a technique related to a machine learning model in consideration of fairness has been proposed. For example, a learning apparatus that inputs training data for learning a classifier and a causal graph representing a causal relationship between variables included in the training data has been proposed. This learning apparatus learns a classifier by solving a constrained optimization problem in which an average of causal effects between predetermined variables is within a predetermined range and a variance of the causal effects is equal to or less than a predetermined value using input training data and a causal graph.

For example, an information processing apparatus that artificially increases data with a small number of attributes to generate learning data for performing fair determination on each input data has been proposed. The information processing apparatus holds first learning data used for learning of a machine learning model, acquires information regarding bias of the learning data, and generates second learning data using data included in the learning data based on the information regarding the bias. Then, the information processing apparatus learns the machine learning model using the first learning data and the second learning data.

For example, a system for labeling unlabeled data according to an amount of label bias has been proposed. The system samples the input data according to discrepancies between the amounts of selection biases and rarities of features and trains the classifier using sampled and labeled data and additional unlabeled data.

As a method of executing training of a machine learning model by active learning in consideration of fairness, a method in which active learning and semi-supervised learning are integrated has been proposed. This approach selects the most valuable unlabeled data and sends it to an expert system for labeling. This approach establishes a connection between unlabeled data and labeled data, improves the model using unique information of the unlabeled data, and assigns pseudo-labels to those samples.

### PRIOR ART DOCUMENT

### Patent Literature

Patent Literature 1: WO 2021/084609
Patent Literature 2: WO 2022/123907
Patent Literature 3: US 2020/0372406 A

### Non-Patent Literature

Non-Patent Literature 1: Quan Ren, Hongbing Zhang, Dailu Zhang, Xiang Zhao, Lizhi Yan, Jianwen Rui, Fanxin Zeng, Xinyi Zhu, “A framework of active learning and semi-supervised learning for lithology identification based on improved naive Bayes,” Expert Systems with Applications, Volume 202, 15 Sep. 2022, 117278.

### SUMMARY

According to an aspect of the embodiments, a non-transitory recording medium storing a program executable by a computer to perform machine learning program processing, the processing comprising: calculating an independence between a prediction result in a case in which each of a plurality of items of unlabeled data is input to a machine learning model, and a value of a first attribute of each of the plurality of items of data; selecting first data from the plurality of items of data based on the independence; acquiring a label of the first data; and executing training of the machine learning model based on the first data and the label.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing active learning.

FIG. 2 is a diagram for describing conventional fair active learning.

FIG. 3 is a diagram for describing fair active learning in the present embodiment.

FIG. 4 is a functional block diagram of a machine learning apparatus according to the present embodiment.

FIG. 5 is a diagram for describing an example of a degree of accuracy improvement.

FIG. 6 is a block diagram illustrating a schematic configuration of a computer functioning as a machine learning apparatus.

FIG. 7 is a flowchart illustrating an example of machine learning processing.

FIG. 8 is a diagram illustrating comparison between the present method and a comparative method regarding prediction accuracy, fairness, and an execution time of fair active learning of a machine learning model.

### DESCRIPTION OF EMBODIMENTS

Hereinafter, an example of an embodiment according to the disclosed technology will be described with reference to the drawings.

Before describing details of the embodiment, fair active learning of a machine learning model and a problem thereof will be described.

First, training of a machine learning model is to learn a relationship between a label (outcome variable) of data and a feature amount (explanatory variable) and to specify a parameter that approximates the relationship. Fairness in machine learning means that there is no bias or discrimination based on congenital or acquired characteristics (hereinafter, referred to as “protected attribute”) of individuals or groups in decision-making in a prediction result by a machine learning model. In social implementation of the machine learning model, improvement of indicators of fairness and disparity based on a group, such as a gender difference in loan examination, a race difference in face recognition, and an age difference in disease diagnosis, is often needed. Therefore, it is important to train the machine learning model so as to obtain a fair prediction result. Since fairness of the machine learning model and prediction accuracy are in a trade-off relationship, it is also important to balance these.

In a case in which a machine learning model is trained by supervised learning, data to which a label indicating a correct answer (hereinafter referred to as “labeled data”) is given is needed. Labeled data is data tagged with one or more labels. Labels are typically tagged by an oracle that is a human or another source of information. Without a sufficient number of labeled data, it is not possible to sufficiently improve the fairness and the prediction accuracy of the machine learning model. However, labeled data is more expensive to collect than unlabeled data (hereinafter referred to as “unlabeled data”).

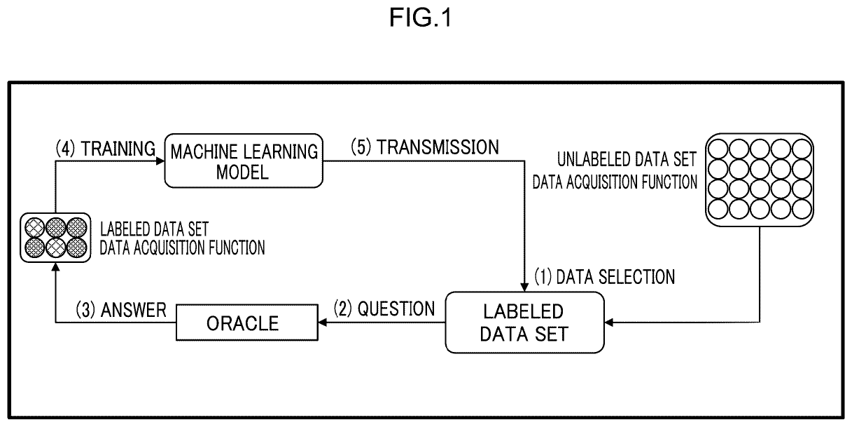

Active learning is an interactive machine learning method of improving a machine learning model by question. Specifically, as illustrated in FIG. 1, the information processing apparatus that executes active learning executes processing of (1) data selection, (2) question, (3) answer, (4) training, and (5) transmission.

More specifically, the information processing apparatus calculates a data acquisition function for each item of data included in an unlabeled data set as processing of “(1) data selection”, and preferentially selects data useful for training of the machine learning model based on the data acquisition function. The data acquisition function is an index representing ambiguity of prediction by the machine learning model for each item of data, representativeness of each item of data with respect to the unlabeled data set, and the like using information such as a parameter of the current machine learning model. The information processing apparatus inquires of the oracle about the label of the selected data as processing of “(2) Question”. As the processing of “(3) answer”, the information processing apparatus acquires a label that is an answer from the oracle, gives the acquired label to the selected data to obtain labeled data, and adds the labeled data to a labeled data set. The information processing apparatus trains the machine learning model using the labeled data set as processing of “(4) training”. The information processing apparatus transmits information such as a parameter of the machine learning model after training to the processing of (1) data selection as the processing of “(5) transmission”.

In the active learning, labeling is preferentially performed from data useful for training of the machine learning model among items of unlabeled data by repeatedly executing the processing of the above (1) to (5), so that the labeled data can be effectively collected.

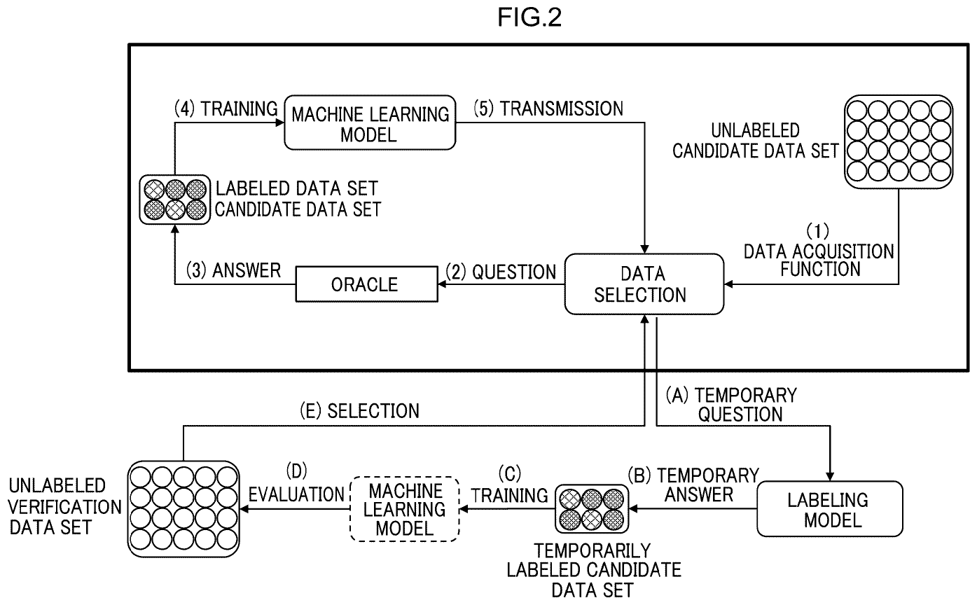

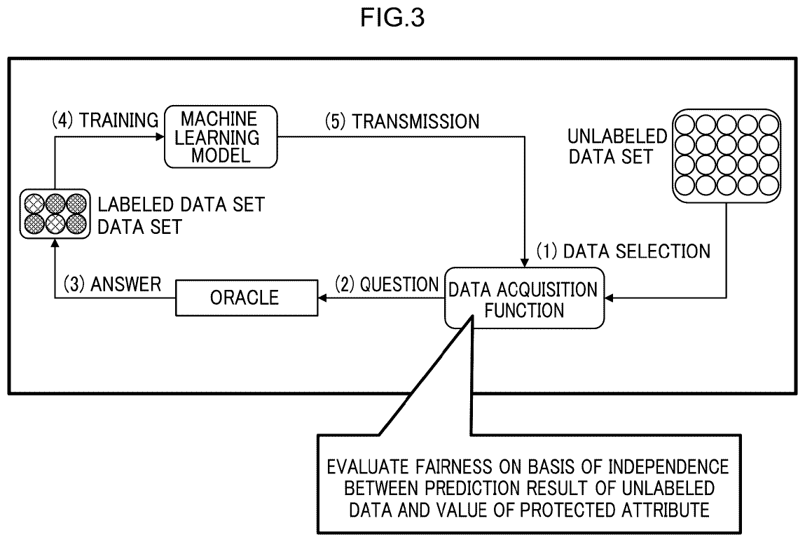

In FIG. 1, a circle represents each item of data, a white circle represents unlabeled data, a hatched circle represents labeled data, and a difference in hatching represents a difference in label. The same applies to FIGS. 2 and 3 below.

In normal active learning, in (1) data selection, data useful for improving prediction accuracy of a machine learning model is selected, and fairness is not considered. Thus, as labeled data is added and training of the machine learning model progresses, the fairness may deteriorate. For example, in a machine learning model for face expression recognition, only data of a specific race may be selected from an unlabeled data set.

Accordingly, in the conventional fair active learning, data is selected in consideration of a trade-off between fairness and prediction accuracy in (1) data selection processing. Specifically, as illustrated in FIG. 2, in the conventional fair active learning, a part of the unlabeled data set is set as an unlabeled verification data set, and the rest is set as an unlabeled candidate data set. An information processing apparatus that executes the conventional fair active learning executes processing of (A) temporary question, (B) temporary answer, (C) training, (D) evaluation, and (E) selection illustrated in FIG. 2, thereby estimating a degree of unfairness improvement of a machine learning model in verification data for each item of candidate data.

More specifically, the information processing apparatus inputs each item of candidate data to a labeling model that outputs a temporary label for data as processing of “(A) temporary question”. The information processing apparatus acquires the temporary label output from the labeling model as the processing of “(B) temporary answer”, and assigns the acquired temporary label to each item of candidate data to obtain a temporarily labeled candidate data set. The information processing apparatus trains the machine learning model using the temporarily labeled candidate data set as the processing of “(C) training”. The information processing apparatus evaluates the fairness of each item of temporarily labeled candidate data in consideration of a difference in unfairness of the machine learning model before and after training using the unlabeled verification data set as the processing of “(D) evaluation”. The information processing apparatus evaluates the prediction accuracy of the machine learning model using the unlabeled verification data set. The information processing apparatus selects candidate data having the best value based on an index in consideration of a trade-off between fairness and prediction accuracy as the processing of “(E) selection”.

In the conventional fair active learning, since training of the machine learning model is executed in “(1) data selection”, data with which prediction accuracy is improved is selected in consideration of a decision boundary of the machine learning model. By the evaluation using the verification data, data with which fairness also improves is selected. However, training of the machine learning model has a high processing load, and there is a problem that it is not possible to efficiently execute data selection. In particular, when the machine learning model is a complex model such as a deep learning model or a nonlinear model, it is difficult to apply fair active learning in a realistic execution time.

Accordingly, in the present embodiment, as illustrated in FIG. 3, the fairness of each item of candidate data is evaluated based on independence between the prediction result of the model for unlabeled data and a value of a protected attribute without requiring training of the machine learning model.

As an easily conceivable means for solving the above problem, it is conceivable to estimate the degree of unfairness of each item of candidate data based on the prediction result of the machine learning model for each item of candidate data and select data having a low degree of unfairness from the unlabeled candidate data set. However, in this case, the influence on the verification data is not considered for the data to be selected, the representativeness of the data becomes low, for example, an outlier or similar data is easily selected. Accordingly, in the present embodiment, the prediction result of the verification data in a case in which the candidate data is given is used as the prediction result of the model for the unlabeled data. Hereinafter, a machine learning apparatus according to the present embodiment will be described.

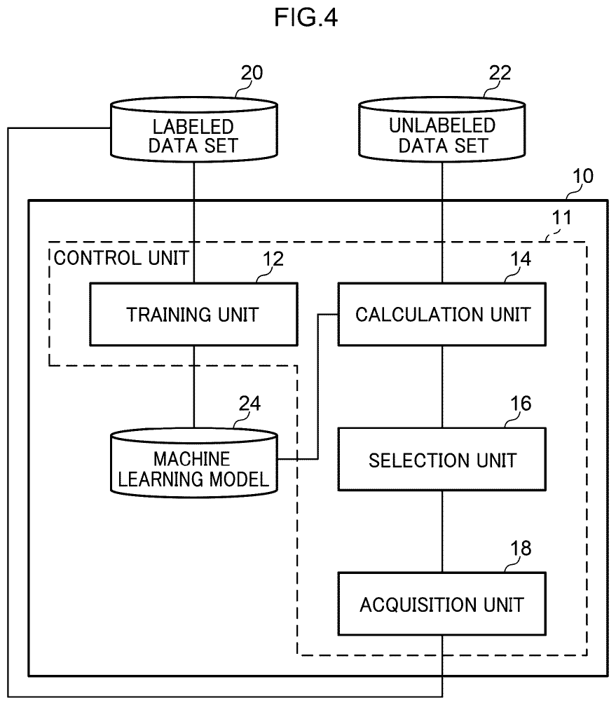

As illustrated in FIG. 4, a labeled data set 20 and an unlabeled data set 22 are input to the machine learning apparatus 10. It is assumed that the number of items of labeled data included in the labeled data set 20 is quite smaller than the number of items of unlabeled data included in the unlabeled data set 22. The machine learning apparatus 10 selects data in consideration of fairness from the unlabeled data set 22 and executes training of a machine learning model 24. That is, the machine learning apparatus 10 executes fair active learning.

The machine learning apparatus 10 functionally includes a control unit 11 as illustrated in FIG. 4. The control unit 11 further includes a training unit 12, a calculation unit 14, a selection unit 16, and an acquisition unit 18. The machine learning model 24 is stored in a predetermined storage area of the machine learning apparatus 10.

The training unit 12 executes training of the machine learning model 24 using a plurality of labeled data included in the labeled data set 20 as training data. As described later, in the present embodiment, the acquisition unit 18 adds new labeled data to the labeled data set 20. In a case in which the new labeled data is added to the labeled data set 20, the training unit 12 executes training of the machine learning model 24 using the initial labeled data and the added labeled data.

The calculation unit 14 calculates the independence between the prediction result (hereinafter, referred to as “prediction label”) in case in which each of the plurality of items of unlabeled data included in the unlabeled data set 22 is input to the machine learning model 24 and the value of the protected attribute of each of the plurality of items of data. The protected attribute is an example of a “first attribute” of the disclosed technology. The calculation unit 14 calculates a mutual information amount between the prediction label and the value of the protected attribute as the independence. The mutual information amount is an index quantitatively indicating whether or not two variables are dependent on each other, and when the two variables are completely independent of each other, the mutual information amount is 0. That is, when the mutual information amount between the prediction label and the value of the protected attribute is 0, it can be said that the machine learning model 24 is completely fair. Therefore, it can be said that unlabeled data having the smallest mutual information amount is the most fair data.

In the present embodiment, the calculation unit 14 calculates the degree of unfairness improvement of the machine learning model 24 based on the mutual information amount between the prediction label and the value of the protected attribute for the verification data conditioned with each item of candidate data. Specifically, the calculation unit 14 sets a part of a plurality of items of unlabeled data included in the unlabeled data set 22 as verification data and sets data other than the verification data as candidate data. The calculation unit 14 calculates independence between the prediction label of each item of the verification data and the value of the protected attribute, the independence being conditioned on independence between the prediction label of each item of candidate data and the value of the protected attribute.

More specifically, the calculation unit 14 calculates a difference between a mutual information amount I between a prediction label Yᵥ of verification data v and a value Sᵥ of the protected attribute in the verification data v before and after candidate data u is given as the degree of unfairness improvement Fu of the candidate data u by the following Formula (1).

$$\begin{matrix}[ Math . 1 ] & \\ {F}_{u} = {\sum }_{v} \{ I ( {Y}_{v} ; {S}_{v} ) - I ( {Y}_{v} ; {S}_{v} \vert {Y}_{u} , {S}_{u} ) \} & ( 1 )\end{matrix}$$

(1) In the formula, Yu represents the prediction label of the candidate data u, and Su represents the value of the protected attribute in the candidate data u. (1) The first term in Σ on the right side of the formula is the mutual information amount of the verification data v before the candidate data u is given, and the second term is the mutual information amount of the verification data v after the candidate data u is given. (1) In the case of the formula, the candidate data u having a larger value of the degree of unfairness improvement Fᵤ indicates that the degree of unfairness improvement is higher.

The calculation unit 14 calculates the second term in Σ on the right side of Formula (1) as follows. First, the calculation unit 14 converts the second term into the following Formula (2). (2) In the formula, H(X) is an entropy of X.

$$\begin{matrix}[ Math . 2 ] & \\ I ( {Y}_{v} ; {S}_{v} \vert {Y}_{u} , {S}_{u} ) = H ( {Y}_{v} \vert {Y}_{u} , {S}_{u} ) - H ( {Y}_{v} \vert {S}_{v} , {Y}_{u} , {S}_{u} ) = \{ H ( {Y}_{v} , {Y}_{u} , {S}_{u} ) - H ( {Y}_{u} , {S}_{u} ) \} - \{ H ( {Y}_{v} , {S}_{v} , {Y}_{u} , {S}_{u} ) - H ( {S}_{v} , {Y}_{u} , {S}_{u} ) \} & ( 2 )\end{matrix}$$

Next, the calculation unit 14 approximates a probability distribution corresponding to each entropy by Monte Carlo dropout. Assuming that the parameter of the machine learning model 24 and the distribution of the prediction label of the machine learning model 24 are conditionally independent, the calculation unit 14 calculates the probability P(Yᵢ) of Yᵢ by the following Formula (3). Here, Yᵢ={Yᵥ, Sᵥ, Yᵤ, Sᵤ}.

$$\begin{matrix}[ Math . 3 ] & \\ P ( {Y}_{i} ) = P ( {Y}_{i} \vert θ ) \approx \frac{1}{M} {\sum }_{m = 1}^{M} P ( {Y}_{i} \vert θ ) & ( 3 )\end{matrix}$$

(3) In the formula, θ is a parameter of the machine learning model 24, and M is the number of times of Monte Carlo sampling. The calculation unit 14 calculates the mutual information amount of Formula (2) using the probability distribution of Formula (3).

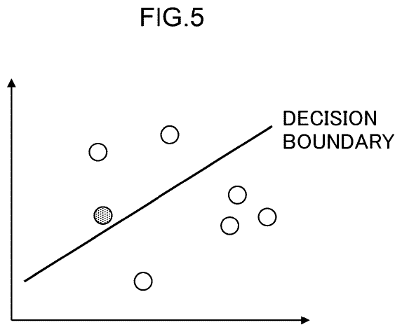

The calculation unit 14 calculates, for each item of candidate data, the degree of improvement in prediction accuracy of the machine learning model 24 by each item of candidate data based on uncertainty of the prediction result when each item of candidate data is input to the machine learning model 24. For example, data located near a decision boundary of the machine learning model 24 can be said to be data that is difficult for the machine learning model 24 to determine, and thus, by using such data as training data, the prediction accuracy of the machine learning model 24 can be improved. For example, in the machine learning model 24, as illustrated in FIG. 5, it is assumed that a decision boundary is defined in a feature space. In the example of FIG. 5, an example of binary classification of a linear model is illustrated, and each circle represents a feature amount of each item of data. In this case, data near the decision boundary (for example, data indicated by a halftone circle in FIG. 5) is unstable to which label it belongs, and is useful for improving the accuracy of the machine learning model 24. Accordingly, the calculation unit 14 calculates the degree of accuracy improvement that becomes higher as the candidate data is closer to the decision boundary of the machine learning model. For example, the calculation unit 14 calculates entropy indicating uncertainty of the prediction label Yᵤ of the candidate data u as the degree of accuracy improvement Aᵤ as expressed in the following Formula (4). (4) In the formula, Y is a set of prediction labels of the machine learning model 24.

$$\begin{matrix}[ Math . 4 ] & \\ {A}_{u} = H ( {Y}_{u} \vert u ) = - {\sum }_{{Y}_{u} ∈ Y} P ( {Y}_{u} \vert u ) log P ( {Y}_{u} \vert u ) & ( 4 )\end{matrix}$$

The calculation unit 14 calculates an evaluation value Eu for each item of the candidate data u represented by the degree of unfairness improvement Fᵤ, the degree of accuracy improvement Aᵤ, and a coefficient α representing a trade-off between the degree of unfairness improvement Fᵤ and the degree of accuracy improvement Aᵤ, for example, as expressed in the following Formula (5).

$${E}_{u} = α \times {F}_{u} + ( 1 - α ) \times {A}_{u} \qquad ( 5 )$$

α is a value of 0 to 1 (for example, 0.6), and is a coefficient that defines how much priority is given to which of the degree of unfairness improvement Fᵤ and the degree of accuracy improvement Aᵤ.

The selection unit 16 selects target data to be labeled from the plurality of items of the candidate data u based on the evaluation value Eᵤ for each item of the candidate data u calculated by the calculation unit 14. The target data is an example of “first data” of the disclosed technology. For example, the selection unit 16 may select the candidate data u having the highest evaluation value Eᵤ, may select the candidate data u having the evaluation value Eᵤ equal to or more than a predetermined value, or may select a top predetermined number of items of the candidate data u having the evaluation value Eᵤ.

The acquisition unit 18 inquires of an oracle that is a human or another source of information about the label of the target data selected by the selection unit 16, and acquires a label that is an answer from the oracle. The acquisition unit 18 assigns the acquired label to the target data to obtain labeled data, and adds the labeled data to the labeled data set 20. Thus, as described above, the training unit 12 executes training of the machine learning model 24 also using the added labeled data.

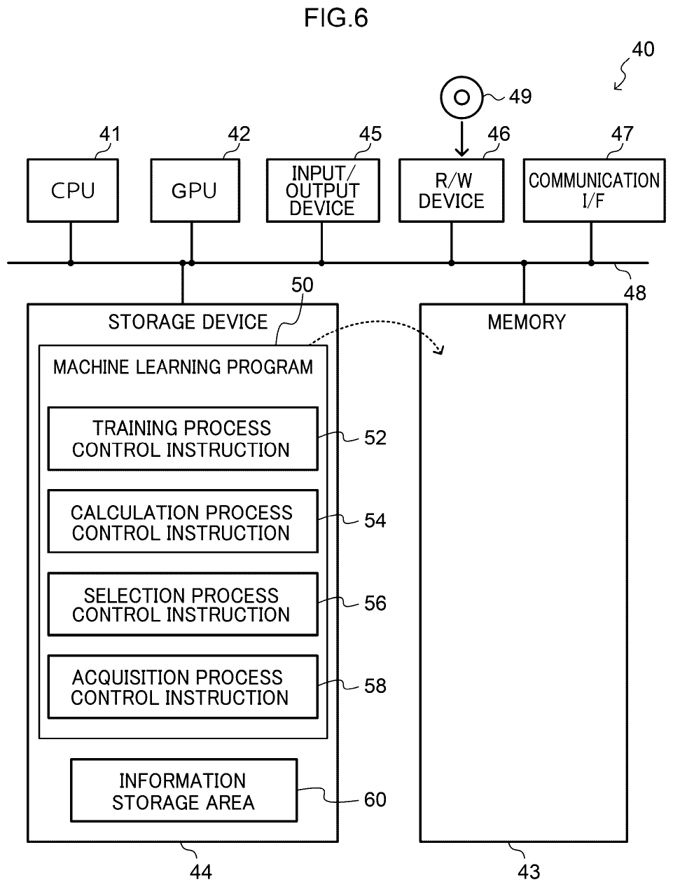

The machine learning apparatus 10 may be implemented by, for example, a computer 40 illustrated in FIG. 6. The computer 40 includes a central processing unit (CPU) 41, a graphics processing unit (GPU) 42, a memory 43 as a temporary storage area, and a nonvolatile storage device 44. The computer 40 includes an input/output device 45 such as an input device and a display device, and a read/write (R/W) device 46 that controls reading and writing of data with respect to the storage medium 49. The computer 40 further includes a communication interface (I/F) 47 connected to a network such as the Internet. The CPU 41, the GPU 42, the memory 43, the storage device 44, the input/output device 45, the R/W device 46, and the communication I/F 47 are connected to each other via a bus 48.

The storage device 44 is, for example, a hard disk drive (HDD), a solid state drive (SSD), a flash memory, or the like. The storage device 44 as a storage medium stores a machine learning program 50 for causing the computer 40 to function as the machine learning apparatus 10. The machine learning program 50 has a training process control instruction 52, a calculation process control instruction 54, a selection process control instruction 56, and an acquisition process control instruction 58. The storage device 44 includes an information storage area 60 in which information constituting the machine learning model 24 is stored.

The CPU 41 reads the machine learning program 50 from the storage device 44, develops the program in the memory 43, and sequentially executes the control instructions included in the machine learning program 50. The CPU 41 operates as the training unit 12 illustrated in FIG. 4 by executing the training process control instruction 52. The CPU 41 operates as the calculation unit 14 illustrated in FIG. 4 by executing the calculation process control instruction 54. The CPU 41 operates as the selection unit 16 illustrated in FIG. 4 by executing the selection process control instruction 56. The CPU 41 operates as the acquisition unit 18 illustrated in FIG. 4 by executing the acquisition process control instruction 58. The CPU 41 reads information from the information storage area 60 and develops the machine learning model 24 in the memory 43. Thus, the computer 40 that has executed the machine learning program 50 functions as the machine learning apparatus 10. The CPU 41 that executes the program is hardware. A part of the program may be executed by a GPU 62.

Functions implemented by the machine learning program 50 may be implemented by, for example, a semiconductor integrated circuit, more specifically, an application specific integrated circuit (ASIC), a field-programmable gate array (FPGA), or the like.

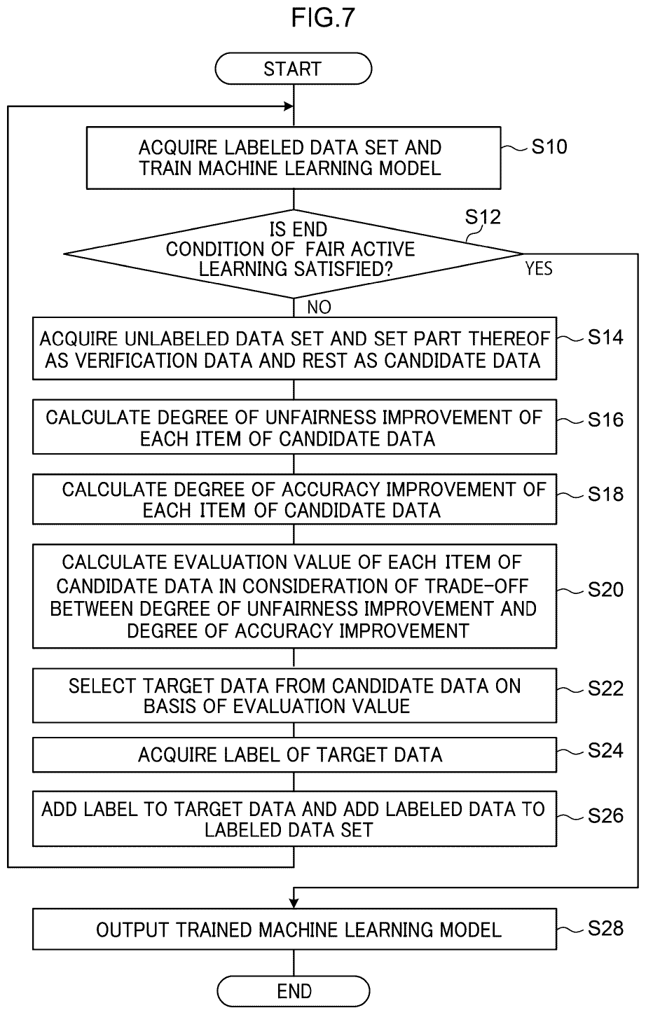

Next, an operation of the machine learning apparatus 10 according to the present embodiment will be described. When fair active learning for the machine learning model 24 is instructed, the machine learning apparatus 10 executes the machine learning processing illustrated in FIG. 7. The machine learning processing is an example of a machine learning method of the disclosed technology.

In step S10, the training unit 12 acquires the labeled data set 20 and performs training of the machine learning model 24 using the labeled data as training data. Next, in step S12, the training unit 12 determines whether or not the end condition of the fair active learning is satisfied. The end condition may be, for example, a case in which the number of data newly added to the labeled data set 20 exceeds a predetermined number. When the end condition is not satisfied, the process proceeds to step S14.

In step S14, the calculation unit 14 sets a part of the plurality of items of unlabeled data included in the unlabeled data set 22 as verification data and the rest as candidate data. Next, in step S16, the calculation unit 14 calculates a difference between the mutual information amount I between the prediction label Yᵥ of the verification data v and the value Sᵥ of the protected attribute in the verification data v before and after the candidate data u is given as the degree of unfairness improvement Fᵤ of each item of the candidate data u, for example, as illustrated in Formula (1).

Next, in step S18, the calculation unit 14 calculates, as the degree of accuracy improvement Aᵤ, entropy indicating uncertainty of the prediction label Yᵤ of each item of the candidate data u, for example, as illustrated in Formula (4). Next, in step S20, the calculation unit 14 calculates the evaluation value Eᵤ for each item of the candidate data u represented by, for example, the degree of unfairness improvement Fᵤ, the degree of accuracy improvement Aᵤ, and the coefficient α representing a trade-off between the degree of unfairness improvement Fᵤ and the degree of accuracy improvement Aᵤ expressed by Formula (5).

Next, in step S22, the selection unit 16 selects target data to be labeled from a plurality of items of the candidate data u based on the evaluation value Eᵤ for each item of the candidate data u. Next, in step S24, the acquisition unit 18 inquires of the oracle about the label of the target data, and acquires the label which is an answer from the oracle. Next, in step S26, the acquisition unit 18 adds the acquired label to the target data to obtain labeled data, adds the labeled data to the labeled data set 20, and deletes the candidate data as the target data from the unlabeled data set 22, and returns to step S10.

Returning to step S10, the training unit 12 also uses the added labeled data to execute training of the machine learning model 24. Next, when it is determined in step S12 that the end condition of the fair active learning is satisfied, the process proceeds to step S28. In step S28, the training unit 12 outputs the trained machine learning model by the fair active learning, and the machine learning processing ends.

As described above, the machine learning apparatus according to the present embodiment calculates independence between a prediction result in a case in which each of a plurality of items of unlabeled data is input to a machine learning model and a value of a protected attribute of each of the plurality of items of unlabeled data. The machine learning apparatus selects target data from the plurality of items of unlabeled data based on the calculated independence, inquires of the oracle to acquire a label of the target data, and executes training of the machine learning model based on the target data and the acquired label. That is, the machine learning apparatus according to the present embodiment evaluates the fairness of the unlabeled data based on the information theoretical approach, and selects data to be labeled without relearning of the machine learning model. Thus, the machine learning apparatus according to the present embodiment can reduce the processing load of fair active learning.

The machine learning apparatus according to the present embodiment calculates, for each item of candidate data, the degree of unfairness improvement using the mutual information amount as the independence between the prediction result and the value of the protected attribute, and calculates the degree of accuracy improvement of the machine learning model based on uncertainty of the candidate data. Then, the machine learning apparatus selects the target data based on the evaluation value considering the trade-off between the degree of unfairness improvement and the degree of accuracy improvement. Thus, the machine learning apparatus according to the present embodiment can select, as the target data, data that optimizes the trade-off between the degree of unfairness improvement and the degree of accuracy improvement while reducing the processing load.

The machine learning apparatus according to the present embodiment sets a part of the unlabeled data as verification data and the rest as candidate data, and calculates a difference in the mutual information amount between the prediction result of the verification data and the value of the protected attribute before and after giving the candidate data as the degree of unfairness improvement. In this way, by calculating the degree of unfairness improvement of the candidate data in consideration of the influence on the verification data, data having high representativeness is easily selected from the candidate data.

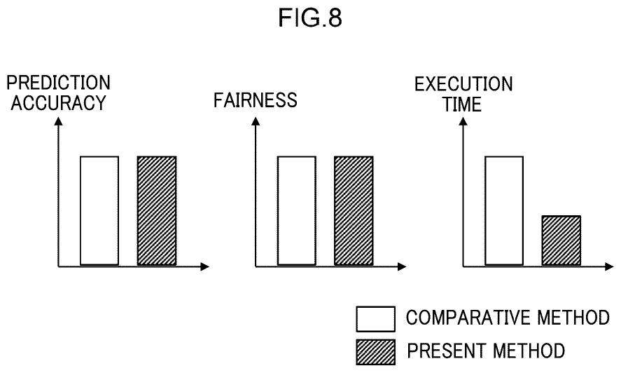

FIG. 8 schematically illustrates a comparison between the method of the present embodiment (hereinafter referred to as “the present method”) and a comparative method regarding prediction accuracy, fairness, and an execution time of fair active learning of the machine learning model. The comparative method here is a method that requires relearning of a machine learning model when selecting data to be labeled as in the method described in Non Patent Literature 1. The present method is equivalent to the comparative method in the trade-off between the prediction accuracy and the fairness. The present method significantly reduces the execution time as compared with the comparative method. The theoretical calculation cost of the fair active learning is “O((T+Nᵥ)CNᵤ)” in the comparative method and “O(NᵤNᵥC²M)” in the present method. T is a calculation cost of training of the machine learning model, Nᵥ is the number of verification data, Nᵤ is the number of candidate data, C is the number of labels, and M is the number of Monte Carlo sampling.

In the above embodiment, the case in which the fairness is evaluated using a part of the unlabeled data as the verification data has been described, but the present invention is not limited thereto. All data included in the unlabeled data set may be set as the candidate data. In this case, as the index of the fairness, for example, it is sufficient if a formula excluding the second term in Σ on the right side of the Formula (1) is used. In the above embodiment, the case in which data is selected using an evaluation value in consideration of a trade-off between fairness and prediction accuracy has been described, but data may be selected in consideration of only the fairness.

In the above embodiment, the case in which the mutual information amount is used as an index indicating the independence between the prediction result of the machine learning model for the unlabeled data and the value of the protected attribute has been described. The mutual information amount may be any amount as long as the independence between the prediction result and the value of the protected attribute can be defined in a mathematical manner, and for example, the Kullback-Leibler divergence, the Yensen-Shanon divergence, covariance, the demographic parity difference, the disparate impact ratio, or the like may be applied.

In a conventional learning method (hereinafter referred to as “fair active learning”) in which training of a machine learning model is executed by active learning in consideration of fairness, training of a machine learning model is needed even in processing of selecting data to be labeled, and there is a problem that a processing load is high.

As one aspect, the disclosed technology has an effect that a processing load of fair active learning can be reduced.

In the above embodiment, the machine learning program is stored (installed) in the storage device in advance, but the present invention is not limited thereto. The program according to the disclosed technology may be provided in a form stored in a storage medium such as a CD-ROM, a DVD-ROM, or a USB memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

### DESCRIPTION OF REFERENCE NUMERALS

10 Machine learning apparatus
11 Control unit
12 Training unit
14 Calculation unit
16 Selection unit
18 Acquisition unit
20 Labeled data set
22 Unlabeled Data Set
24 Machine learning model
40 Computer
41 CPU
42 GPU
43 Memory
44 Storage device
45 Input/output device
46 R/W device
47 Communication I/F
48 Bus
49 Storage medium
50 Machine learning program
52 Training process control instruction
54 Calculation process control instruction
56 Selection process control instruction
58 Acquisition process control instruction
60 Information storage area

What is claimed is:

1. A non-transitory recording medium storing a program executable by a computer to perform machine learning program processing, the processing comprising:
calculating an independence between a prediction result in a case in which each of a plurality of items of unlabeled data is input to a machine learning model, and a value of a first attribute of each of the plurality of items of data;
selecting first data from the plurality of items of data based on the independence;
acquiring a label of the first data; and
executing training of the machine learning model based on the first data and the label.

2. The non-transitory recording medium according to claim 1, wherein the independence is a mutual information amount between the prediction result and the value of the first attribute.

3. The non-transitory recording medium to claim 1, wherein selecting the first data includes selecting based on a degree of improvement in prediction accuracy of the machine learning model due to each of the plurality of items of data based on an uncertainty of a prediction result in a case in which each of the plurality of items of data is input to the machine learning model, and based on the independence.

4. The non-transitory recording medium according to claim 3, wherein the degree of improvement increases the closer the first data is to a decision boundary of the machine learning model.

5. The non-transitory recording medium according to claim 3, wherein selecting the first data includes selecting a predetermined number of items of the data in which an index represented by the degree of improvement, the independence, and a coefficient representing a trade-off between the degree of improvement and the independence, is equal to or more than a predetermined value, or selecting a predetermined number of items of the data having the highest indices.

6. The non-transitory recording medium to claim 1, wherein:
calculating the independence includes configuring a part of the plurality of items of data as verification data and configuring data other than the verification data among the plurality of items of data as candidate data, and calculating an independence between a prediction result in a case in which each item of the verification data is input to the machine learning model, and the value of the first attribute of each item of the verification data, the independence being predicated on an independence between a prediction result in a case in which each item of the candidate data is input to the machine learning model, and the value of the first attribute of each item of the candidate data, and
selecting the first data includes selecting the first data from the candidate data.

7. A machine learning method executable by a computer to perform a process, the process comprising:
calculating an independence between a prediction result in a case in which each of a plurality of items of unlabeled data is input to a machine learning model, and a value of a first attribute of each of the plurality of items of data;
selecting first data from the plurality of items of data based on the independence;
acquiring a label of the first data; and
executing training of the machine learning model based on the first data and the label.

8. The machine learning method according to claim 7, wherein the independence is a mutual information amount between the prediction result and the value of the first attribute.

9. The machine learning method according to claim 7, wherein selecting the first data includes selecting based on a degree of improvement in prediction accuracy of the machine learning model due to each of the plurality of items of data based on an uncertainty of a prediction result in a case in which each of the plurality of items of data is input to the machine learning model, and based on the independence.

10. The machine learning method according to claim 9, wherein the degree of improvement increases the closer the first data is to a decision boundary of the machine learning model.

11. The machine learning method according to claim 9, wherein selecting the first data includes selecting a predetermined number of items of the data in which an index represented by the degree of improvement, the independence, and a coefficient representing a trade-off between the degree of improvement and the independence, is equal to or more than a predetermined value, or selecting a predetermined number of items of the data having the highest indices.

12. The machine learning method according to claim 7, wherein:
calculating the independence includes configuring a part of the plurality of items of data as verification data and configuring data other than the verification data among the plurality of items of data as candidate data, and calculating an independence between a prediction result in a case in which each item of the verification data is input to the machine learning model, and the value of the first attribute of each item of the verification data, the independence being predicated on an independence between a prediction result in a case in which each item of the candidate data is input to the machine learning model, and the value of the first attribute of each item of the candidate data, and
selecting the first data includes selecting the first data from the candidate data.

13. A machine learning apparatus, comprising:
a memory; and
a processor coupled to the memory, the processor being configured to execute processing, the processing including:
calculating an independence between a prediction result in a case in which each of a plurality of items of unlabeled data is input to a machine learning model, and a value of a first attribute of each of the plurality of items of data;
selecting first data from the plurality of items of data based on the independence;
acquiring a label of the first data; and
executing training of the machine learning model based on the first data and the label.

14. The machine learning apparatus according to claim 13, wherein the independence is a mutual information amount between the prediction result and the value of the first attribute.

15. The machine learning apparatus according to claim 13, wherein selecting the first data includes selecting based on a degree of improvement in prediction accuracy of the machine learning model due to each of the plurality of items of data based on an uncertainty of a prediction result in a case in which each of the plurality of items of data is input to the machine learning model, and based on the independence.

16. The machine learning apparatus according to claim 15, wherein the degree of improvement increases the closer the first data is to a decision boundary of the machine learning model.

17. The machine learning apparatus according to claim 15, wherein selecting the first data includes selecting a predetermined number of items of the data in which an index represented by the degree of improvement, the independence, and a coefficient representing a trade-off between the degree of improvement and the independence, is equal to or more than a predetermined value, or selecting a predetermined number of items of the data having the highest indices.

18. The machine learning apparatus according to claim 13, wherein:
calculating the independence includes configuring a part of the plurality of items of data as verification data and configuring data other than the verification data among the plurality of items of data as candidate data, and calculating an independence between a prediction result in a case in which each item of the verification data is input to the machine learning model, and the value of the first attribute of each item of the verification data, the independence being conditioned on an independence between a prediction result in a case in which each item of the candidate data is input to the machine learning model, and the value of the first attribute of each item of the candidate data, and
selecting the first data includes selecting the first data from the candidate data.
